(19) United States
(12) Patent Application Publication
(10) Pub. No.: US 2009/0161627 A1
(43) Pub. Date: Jun. 25, 2009

(54) Switching communication networks in a mobile device

(75) Inventors: Natarajan Ekambaram, Austin, TX (US); Cinda L. Flynn, Pflugerville, TX (US); Jeffrey Keating, Austin, TX (US); Stephen C. Ma, Austin, TX (US)

Correspondence Address: LAW OFFICE OF CHARLES W. BETHARDS, LLP, P.O. BOX 1622, COLLEYVILLE, TX, 76034, US

(73) Assignee: FreeScale Semiconductor, Inc.

(21) Appl. No.: 12/002,903

(22) Filed: Dec. 19, 2007

(51) Int. Cl. H04Q 7/00

(52) U.S. Cl. 370/331

(57) ABSTRACT

Methods and corresponding systems in a mobile station for switching communication networks include scheduling an alternate network period during a first communication session between a mobile station and a first network transceiver in a first network, wherein the first network uses a first protocol. During the alternate network period the mobile station searches for a transmission from a second network transceiver in a second network, wherein the second network uses a second protocol. A second communication session is requested between the mobile station and the second network transceiver. A second communication session is initiated between the mobile station and the second network transceiver.

### BACKGROUND

1. Field

This disclosure relates generally to communication systems and equipment, and more specifically, to techniques and apparatus in a mobile station for switching between communication networks in a communication system.

2. Related Art

As wireless communication networks become increasingly popular, many mobile stations (e.g. wireless communication devices) can be located in an area that is served by more than one wireless communication network. Frequently, it can be advantageous for the mobile station to switch networks. In some instances, it can be cheaper to use one network instead of another (e.g., one network may charge by the minute, or charge by the amount of data transferred, while the other network may have a fixed cost for virtually unlimited data). Other times, data rates in one network can be different from another network, or the quality of wireless signal reception of one network can be different from another. Thus, for these and other reasons, it can be advantageous for a mobile station to switch from a first network to a second network.

In order to switch between networks that use different communication protocols or standards, the wireless device must be able to communicate using both standards. In order to reduce the cost of the wireless device, the wireless device can be configured so that only a first protocol or a second protocol can be used at one time, thus saving the cost and power consumption that would be required to operate two transceivers with the first and second protocols simultaneously during a process of switching between the networks. It can also be desirable for a mobile device to discover and initiate a communication session with the second network in a manner that can provide an uninterrupted communication session for the mobile device currently in a communication session with the first network.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a high-level block diagram of a communication system that includes a mobile station that can communicate with a first wireless network and a second wireless network in accordance with one or more embodiments;

FIG. 2 is a high-level flowchart of processes in a mobile device for switching between a first and a second network in accordance with one or more embodiments; and

FIGS. 3, 4, and 5 are schematic representations of data and messages exchanged between a mobile device and the first and second networks in accordance with one or more embodiments.

### DETAILED DESCRIPTION

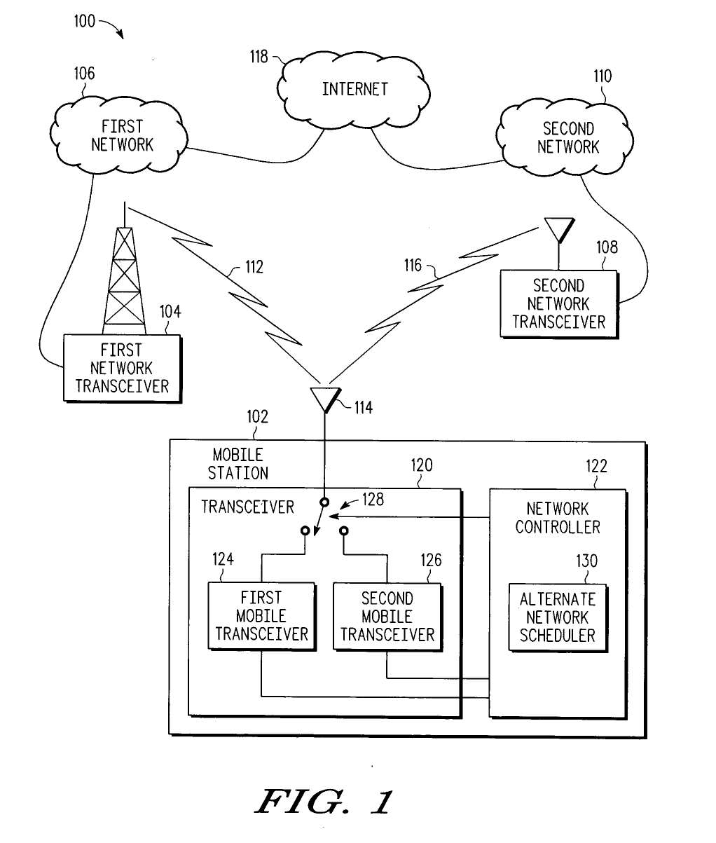

Referring to FIG. 1, a high-level block diagram of a communication system that includes a mobile station that can communicate with a first wireless network and a second wireless network in accordance with one or more embodiments will be briefly discussed and described. As shown, communication system 100 includes mobile station 102, which is capable of communicating with first network transceiver 104 coupled to first network 106 (wherein the network “cloud” can include other similar networked transceiver's and other network elements configured as one or more networks, local area networks (LANs), or combinations thereof), and which is capable of communicating with second network transceiver 108 coupled to second network 1 10 (wherein the network cloud likewise can include other networked transceivers and network elements configured as one or more networks, local area networks (LANs), or combinations thereof).

Mobile station 102 can be any one of several known types of wireless devices, such as a mobile telephone; a wireless personal digital assistant (PDA); a wirelessly networked computer; a music, game, or movie player with wireless communication capability; or other similar wireless device. Mobile station 102 can communicate with first and second networks 106, 110 using different first and second protocols or air interfaces, wherein such protocols are typically precisely defined by detailed specifications or standards published by renowned and respected standards organizations. Examples of such standards organizations include The Institute of Electrical and Electronics Engineers (IEEE), American National Standards Institute (ANSI), International Telecommunication Union (ITU), and the like.

For example, in one embodiment, mobile station 102 can wirelessly communicate with first network transceiver 104 using a first protocol or air interface depicted by wireless signal 112 for transmitting and receiving radio frequency signals between antenna 114 and first network transceiver 104, wherein the first protocol can be any one of several known protocols, such as, the Worldwide Interoperability for Microwave Access (WiMax) protocol based on the IEEE 802.16 standard. Similarly, mobile station 102 can wirelessly communicate with second network transceiver 108 using a second protocol or air interface depicted by wireless signal 116 between antenna 114 and second network transceiver 108, wherein the first protocol can be any one of several known protocols, such as, wireless local area network (WLAN) based on the IEEE 802.11 family of standards for wireless LAN.

Standards published by the various standards organizations can include detailed descriptions of messages and data, and the responses thereto, that are transferred or communicated between a network transceiver and the mobile station transceiver. These messages and data enable the mobile station and the network to establish a “communication session” for the purpose of communicating data using a communication link. Thus, the communication session can include an implicit arrangement or agreement between the network transceiver and the mobile station to use particular communication system resources (e.g., frequencies or channels, bandwidth, timeslots, or other similar resources) in a certain manner for either a defined or undefined period of time without the need for repeated negotiations of authority or parameters or format for using the communication link. Thus, the establishment of a communication session can include the setting of many rules or parameters, or the verification of identities and privileges, or the execution of other tasks, that can be used or relied upon for the duration of the session.

As shown in FIG. 1, first network 106 and second network 110 can be coupled to Internet 118 or other network, which is interconnecting the first and second network. Internet 118 can include a source of data (e.g., a server or other computer (not shown) for providing data representing music, a movie, a webpage, a database, or the like) that can be communicated with mobile station 102. Thus, the Internet data source can be coupled to mobile station 102 for communicating data via either first network 106 or second network 110.

During a communication session, there can be periods of time when mobile station 102 can expect, based upon the protocol defined by the standard, that the network transceiver (e.g. a transceiver, base station, access point, or the like, coupled to additional network resources, such as first network transceiver 104 and second network transceiver 108) will not transmit data to mobile station 102. Such a period without communication from the network can be referred to as a “network quiet time.” For example, in a network using a standard substantially similar to 802.16, a network quiet time can exist following a search request from a mobile station, wherein the period of time following such a search request is intended in the specification to be used by the mobile station to search for another network transceiver that is part of the same 802.16 network.

In various embodiments, mobile station 102 can include transceiver 120 coupled to antenna 114. Transceiver 120 is capable of wireless communication using at least two protocols (e.g., a first protocol for communicating with first network transceiver 104 and a second protocol for communicating with second network transceiver 108). Transceiver 120 can be coupled to network controller 122 for controlling the selection of either the first or second protocols for communication with the respective first or second networks.

Transceiver 120 can include first mobile transceiver 124 for communicating using the first protocol and second mobile transceiver 126 for communicating using the second protocol, wherein an input-output of each mobile transceiver 124, 126 is connected to a terminal of mobile transceiver switch 128. A third input-output terminal of mobile transceiver switch 128 can be coupled to antenna 114. In some embodiments, first mobile transceiver 124 and second mobile transceiver 126 can be totally separate transceivers. In other embodiments, first and second mobile transceivers 124 and 126 can share hardware, or software, or firmware, or some combination of these, to an extent possible while transceiver 120 is able to support the first and second protocols. Thus, mobile transceiver switch 128 can switch input/output signals between two separate mobile transceivers, or mobile transceiver switch 128 can switch or exchange combinations of hardware, software, or firmware so that transceiver 120 can switch between operating with, or supporting, first and second protocols.

Network controller 122 can be coupled to mobile transceiver switch 128 for controlling the routing of input-output signals between antenna 114 and either first mobile transceiver 124 or second mobile transceiver 126. The input-output signals passed though mobile transceiver switch 128 can be either base band signals or radio frequency signals, depending upon whether the mobile transceivers share a radio frequency stage (not shown) that may be between mobile transceiver switch 128 and antenna 114, or whether first and second mobile transceivers 124,126 include their own modulator and radio frequency amplifier stages (not shown).

In order to conserve power and maximize the use of computational resources in mobile station 102, transceiver 120 can be configured to communicate using only one protocol at a time, thus enabling only first mobile transceiver 124 or second mobile transceiver 126 at one time. In this configuration, mobile station 102 cannot communicate simultaneously with first and second network transceivers 104 and 108. Thus, mobile station 102 can be configured to operate in modes that exclusively use a first protocol to communicate with a first network, and exclusively use a second protocol to communicate with the second network, i.e., mobile station 102, and more specifically transceiver 120 operates to support only one of the first and second protocols at any given time.

In order to facilitate switching networks using transceiver 120, which can only communicate with one type of network at a time, network controller 122 can include alternate network scheduler 130, which can be used for scheduling communications with an alternate network (e.g., second network transceiver 108) without interrupting a communication session with a current network (e.g., first network transceiver 104). In one embodiment, alternate network scheduler 130 can determine an “alternate network period,” which can be a period of time during which a transmission from first network transceiver 104 (or any other transceiver used by first network 106) to mobile station 102 is not defined by the first protocol. For example, if first network transceiver 104 uses a first protocol substantially similar to the 802.16 WiMax protocol, an alternate network period can be a period of time following a grant of a search request, wherein the 802.16 protocol allows a search period for a mobile station to search for another 802.16 transceiver. During the search period, transmissions from first network transceiver 104 to mobile station 102 are not defined by the 802.16 specification, in this case because mobile station 102 cannot be expected to receive and respond to any transmission while it is (or is supposed to be) searching other frequencies for another 802.16 transceiver.

In another embodiment, the alternate network period can further include a period of time during which a transmission from first network transceiver 104 can be ignored by mobile station 102 without terminating the first communication session. Examples of transmissions that can be ignored include: a “best effort traffic” transmission, which is a data transmission that can be dropped if the network is congested; a transmission of unscheduled traffic; or transmissions of traffic intended for other users in the network.

Thus, alternate network scheduler 130 can include a knowledge base of periods of time during the operation of various protocols that can be used for alternate network periods. The knowledge base can include commands that mobile station 102 can send to a network transceiver in order to produce an alternate network period. The knowledge base can also include pattern recognition for recognizing message traffic that indicates upcoming periods of time that can be used as an alternate network period.

In addition to scheduling alternate network periods, network controller 122 can also be used to request and initiate a second communication session between mobile station 102 and second network transceiver 108. In some embodiments, initiation of the second communication session can occur prior to termination of the first communication session. Following the initiation of the second communication session, network controller 122 can be used to terminate the first communication session, which can be done by sending a termination request, or by other similar message exchange.

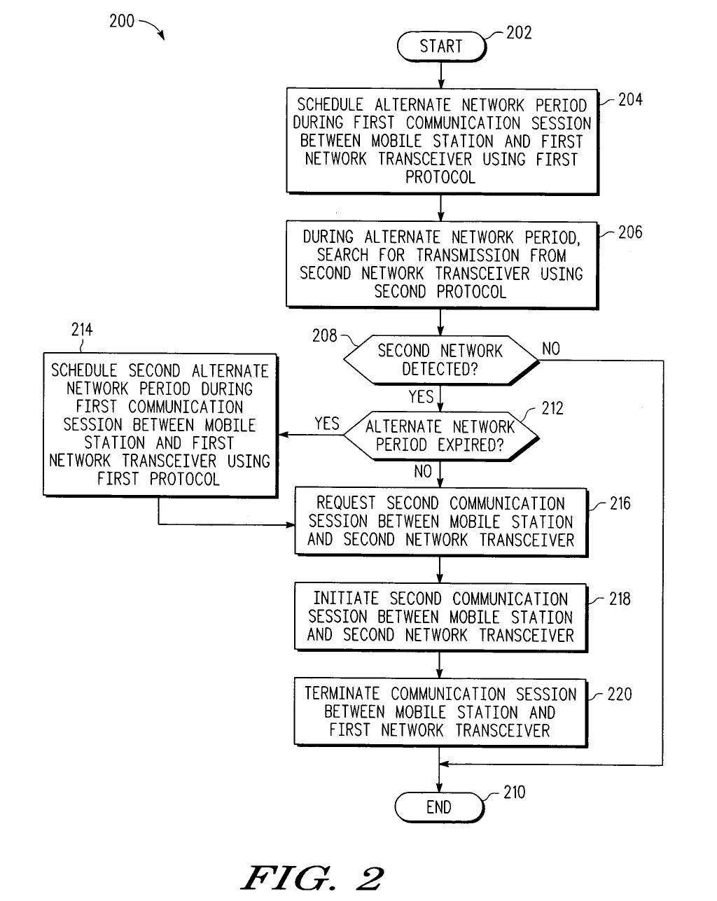

With reference to FIG. 2, there is depicted a high-level flowchart of processes in a mobile device for switching between a first and a second communication network in accordance with one or more embodiments. As illustrated, the process begins at 202, and thereafter passes 204, wherein the process schedules an alternate network period during a first communication session between a mobile station and a first network transceiver that uses a first protocol. The alternate network period is a time segment that can be used by the mobile station to search for and monitor transmissions from an alternate network (i.e., second network), and, in some embodiments, begin to establish a communication session with the second network.

In one embodiment, the alternate network period can be a period in which a transmission from the first network transceiver to the mobile station is not defined by the first protocol. This can be a period of time in which the mobile station (e.g., mobile station 102 in FIG. 1) can reasonably expect, based upon the operation of the first protocol, that it will not be required to receive a transmission from first network transceiver 104 in order to maintain a first communication session between mobile station 102 and first network transceiver 104.

In another embodiment, the alternate network period can be a period wherein a transmission from the first network transceiver to the mobile station can be ignored by the mobile station without terminating the first communication session. For example, in some embodiments, first network transceiver 104 can transmit a data packet that can be ignored by mobile station 102 the first time it is sent without terminating the first communication session. At some point after the packet is ignored, first network transceiver 104 will re-transmit the packet, and mobile station 102 will be expected to respond to maintain the first communication session.

The scheduling of an alternate network period, in one embodiment, can be implemented by mobile station 102 by transmitting a request for a scan interval, wherein the scan interval is intended by the specification to be used by the mobile station to scan other frequencies for additional base stations using the same protocol. For example, in the 802.16 standard, a mobile station can send a request for a scan interval, and the 802.16 transceiver can respond by granting the scan interval to allow the mobile station to scan other frequencies for other 802.16 base stations. The purpose of the scan interval is to allow the mobile station to locate other 802.16 transceivers that may provide improved wireless service (e.g., increased signal strength, or bit rate, or the like).

In another embodiment, the scheduling of an alternate network period can be implemented with the mobile station sending a request for a sleep interval, or other similar period that can be used for an alternate network period.

Next, during the scheduled alternate network period, the process searches for a transmission from a second network transceiver using the second protocol, as depicted at 206. In one embodiment, this can be implemented, for example, in mobile station 102, using network controller 122 to mobile transceiver switch 128 to switch from first mobile transceiver 124 to second mobile transceiver 126 to receive a beacon signal, or other signal, from second network transceiver 108. In one embodiment, switching from first mobile transceiver 124 to second mobile transceiver 126 can be implemented by disabling first mobile transceiver 124 and enabling second mobile transceiver 126, wherein enabling and disabling the transceivers can include switching software, firmware, hardware, or other similar resources to the extent necessary to switch (or enable or disable) operation from the first protocol to the second protocol. By receiving the beacon signal (or other signal), mobile station 102 can detect the presence of second network transceiver 108, and perhaps determine the quality of a wireless signal, or the quality of a communication link that may be established with second network transceiver 108.

As shown at 208, the process determines whether or not the second network has been detected during the alternate network period. If the second network has not been detected, the process of switching communication networks ends at 210. While the process of switching networks ends at 210, the process depicted in flowchart 200 can be periodically repeated as needed in order to locate and connect with the network that provides the most advantageous service to a user of mobile station 102.

If, at 208, the second network has been detected, the process passes to 212, wherein the process determines whether the alternate network period has expired. If the alternate network period has expired, or is close to expiring, the process can return to the first communication session in the first communication network in order to maintain the first communication session, and to schedule a second alternate network period during the first communication session between the mobile station in the first network transceiver using the first protocol, as shown at 214. In some embodiments, the alternate network period can expire when the mobile station must return to the first network in order to maintain the first communication session. For example, mobile station 102 in FIG. 1 may come to the end of a search request period and may need to switch back to first mobile transceiver 124 in order to send or receive a transmission with first network transceiver 104 in order to avoid the termination of the first communication session, which, in some cases, can occur due to lack of responsiveness by the mobile station.

If the second network is detected, and the alternate network period (i.e., either the first alternate network period, or any second or subsequent alternate network period) has not expired, the process requests a second communication session between the mobile station in the second network transceiver, as illustrated at 216. In one embodiment, this can be implemented with mobile station 102 using second mobile transceiver 126 to request service (e.g., begin negotiating for a communications link for a second communication session) from second network transceiver 108.

After requesting the second communication session, the process can initiate the second communication session between the mobile station and the second network transceiver, as depicted at 218. In one embodiment, this can be implemented by using mobile station 102 to initiate a second communication session between mobile station 102 and second network transceiver 108, wherein the second communication session uses a second communication protocol. In some embodiments, the initiating the second communication session at 219 can be implemented during an alternate network period so that a first communication session is not terminated due to the unresponsiveness of mobile station 102 while it is communicating with second network transceiver 108.

After initiating the second communication session, the process can terminate the first communication session between the mobile station in the first network transceiver, as illustrated at 220. In one embodiment, the first communication session can be terminated by transmitting a command from mobile station 102 to first network transceiver 104. In some embodiments, the termination command can include instructions to move or transfer the first communication session from first network 106 to second network 110, using second network transceiver 108.

Terminating the first communication session at 220 can be an optional step. In some embodiments, the first communication session can be terminated by inactivity or lack of response from the mobile station on the first communication network, wherein the first communication session will be allowed to time out, or otherwise expire or terminate.

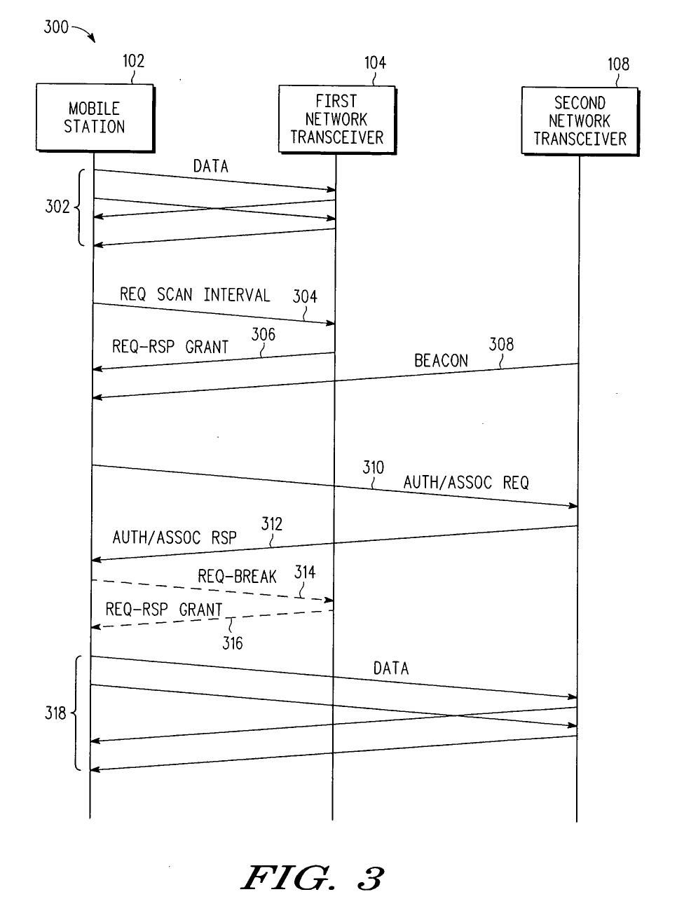

Referring to FIG. 3, there is depicted a schematic representation of data and messages exchanged between a mobile device and a first and a second network in accordance with one or more embodiments. As shown in diagram 300, which may be referred to as a “bounce diagram,” there are representations of three communication nodes: mobile station 102, first network transceiver 104, and second network transceiver 108. At the top of diagram 300, which represents an earliest time of the diagram, data is transmitted between mobile station 102 and first network transceiver 104, as shown at data exchange or data session 302. Data session 302 represents data exchanged during a first communication session between mobile station 102 and first network transceiver 104 using a first protocol. In one embodiment, the first protocol can be a protocol substantially similar to 802.16 WiMax.

At some point during the first communication session (i.e., data session 302), mobile station 102 can schedule an alternate network period by, for example, sending a request for a scan interval to first network transceiver 104, as shown at 304. In response to receiving the request for scan interval 304, first network transceiver 104 can grant a scan interval, as shown at 306. This scan interval grant can include an express or implied grant of a period of time (e.g., a particular number of frame periods beginning at a particular frame).

While the purpose of first network transceiver 104 granting a scan interval is for mobile station 102 to search for additional network transceivers in the first network, in various embodiments, mobile station 102 can use this scan interval for searching for the presence of a second network transceiver using a second protocol (i.e., an alternate network period). During this granted period, or other similar periods that can serve the function of an “alternate network period,” mobile station 102 does not have to receive data from, nor send responses to, first network transceiver 104, which means that mobile station 102 can spend time away from the first network without jeopardizing the first communication session.

During the alternate network period following the grant of the scan interval at 306, mobile station 102 is able to switch from using first mobile transceiver 124 with a first protocol to using second mobile transceiver 126 with a second protocol in order to search for a beacon from second network transceiver 108, wherein the beacon can indicate the presence of the second network transceiver 108 and second network 110. In one embodiment, network controller 122 can send a signal that causes mobile transceiver switch 128 to switch from first mobile transceiver 124 to second mobile transceiver 126 so the mobile station 102 can search for a beacon.

Once first network transceiver 104 has received beacon 308, mobile station 102 can request a second communication session between mobile station 102 and second network transceiver 108 by sending an authorization or association request 310 to second network transceiver 108. Such an authorization or association request can be part of a process of negotiating service that can include a second communication session using a second protocol between mobile station 102 and second network transceiver 108.

In response to receiving authorization/association request 310, second network transceiver 108 can respond by sending authorization/association response 312, which can be part of the initiation of the second communication session between mobile station 102 and second network transceiver 108 using the second protocol.

After initiating the second communication session, mobile station 102 can optionally (represented by the dashed lines) switch back to first mobile transceiver 124 to send request to break 314 to first network transceiver 104 to terminate the first communication session. In response to the optional request to break 314, first transceiver 104 can transmit a break grant 316 to mobile station 102 indicating that the first communication session has been terminated.

In some embodiments, request to break 314 and break grant 316 can include requests, data, or instructions for continuing the service (e.g., listening to and/or watching a streaming media presentation, accessing an Internet server, or the like) of the first communication session in the second communication session between mobile station 102 and second network transceiver 108. Such data or instructions can include an IP address or login instructions so that the first communication session can be transferred to a second communication session on the second network. In an embodiment wherein streaming media is transmitted from the first network, for example, the streaming media presentation “state” can be transferred to the second network.

After the second communication session has been initiated, data can be transferred between mobile station 102 and second network transceiver 108 using the second protocol in the second communication session, as shown at 318.

Note that in some embodiments, there may not be enough time during the alternate network period to receive beacon 308 and to negotiate the initiation of the second communication session, as shown at 310 and 312. Thus, following the reception of beacon 308 in FIG. 3, mobile station 102 can return to communicating with first network transceiver 104 (using first mobile transceiver 124) to schedule an additional alternate network period (e.g., send an additional scan interval request, such as scan interval request 304) in order to schedule additional time to negotiate a second communication session.

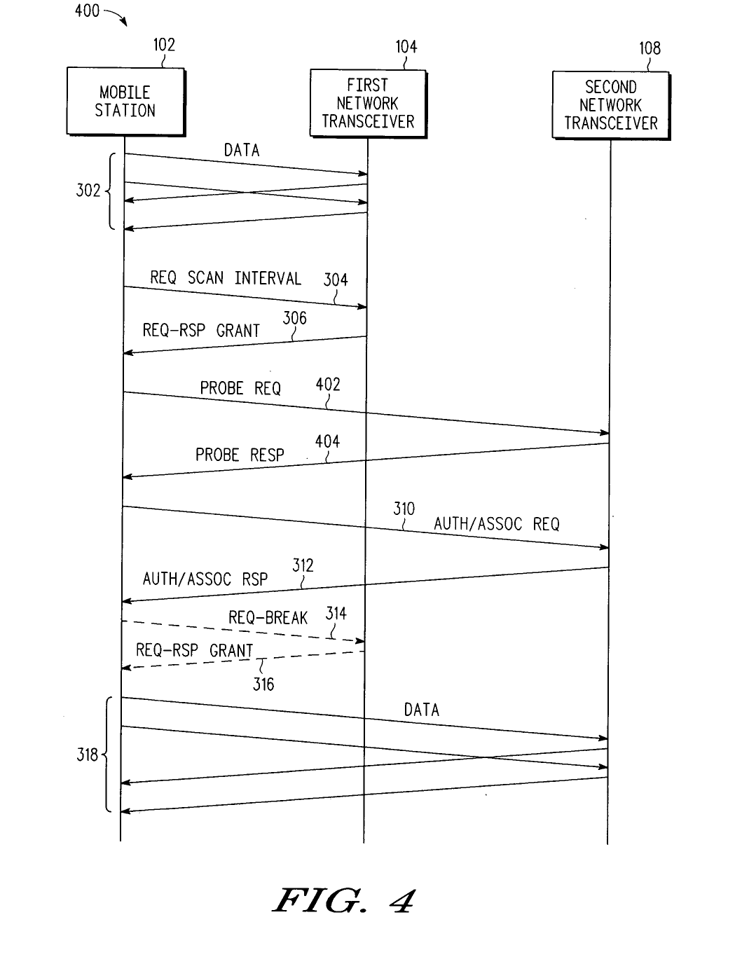

Referring now to FIG. 4, there is depicted a second bounce diagram 400 depicting data and messages exchanged between a mobile device and a first and a second network in accordance with one or more embodiments. FIG. 4 is similar to FIG. 3, with both beginning with first data session 302, which includes data exchanges between mobile station 102 and first network transceiver 104. At some point in first data session 302, mobile station 102 schedules an alternate network period by, for example, sending a request for scan interval 304 and receiving a grant for scan interval 306.

In the embodiment depicted in FIG. 4, mobile station 102 actively searches for second network transceiver 108 by sending a probe request 402, rather than waiting to receive beacon 308 as depicted in FIG. 3. In this “active search mode” probe request 402 transmitted from mobile station 102 causes second network transceiver 108 to respond with probe response 404. In an embodiment where the second protocol is substantially similar to the 802.11 protocol, a “probe request frame” can be sent by mobile station 102 to obtain a response from access points (e.g. a second network transceiver 108) that are within range of mobile station 102. In response to the probe request frame, nearby access points can respond with a “probe response frame,” which frame can contain capability information, supported data rates, and other similar information.

After mobile station 102 sends probe request 402 and receives probe response 404, mobile station can send authorization/association request 310, and receive authorization/association response 312, as discussed above with reference to FIG. 3. Then mobile station 102 can optionally transmit request to break 314, and receive break grant 316, in order to terminate the first communication session. Thereafter, mobile station 102 can continue with the second communication session, as shown at 318.

In an embodiment using an active search mode, such as the embodiment depicted in FIG. 4, the time required to search for second network transceiver 108 can be reduced by eliminating the wait to receive the beacon, or by activating a silent network where beacons are not transmitted, but the power required to search for second network transceiver 108 may be increased because of the transmission of probe request 402.

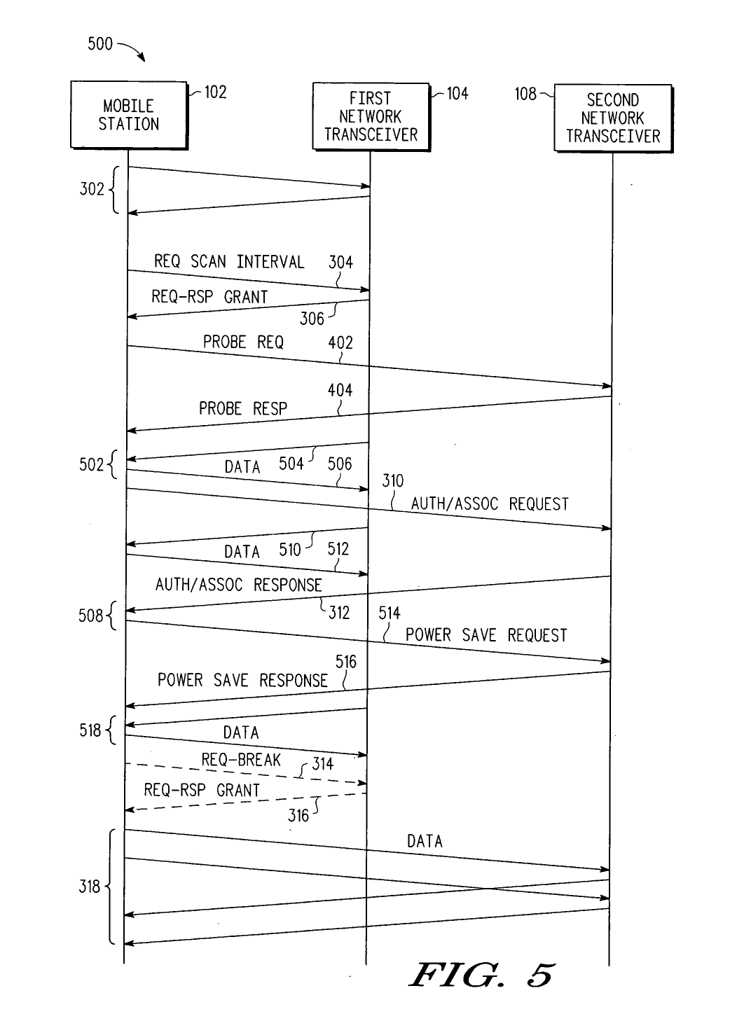

In FIG. 5, there is depicted a third bounce diagram 500 depicting data messages exchanged between a mobile device and a first and a second network in accordance with one or more embodiments. FIG. 5 is similar to both FIGS. 3 and 4, which begin with first data session 302, including data exchanges between mobile station 102 and first network transceiver 104. Mobile station 102 can then schedule an alternate network period by sending a request for scan interval 304 and receiving a scan interval grant 306. During the alternate network period, mobile station 102 can send probe request 402 to second network transceiver 108, and, in response thereto, receive probe response 404 indicating the presence of second network transceiver 108.

In the embodiment depicted in FIG. 5, mobile station 102 can return to communicating with first network transceiver 104, as shown at 502, in order to preserve or continue the first communication session by receiving data at 504 and responding thereto at 506. As part of the data exchanged at 502, mobile station 102 can again request a scan interval (e.g. a second scan interval) and receive a grant for scan interval in order to schedule a second alternate network period.

During a second alternate network period, mobile station 102 can send authorization/association request 310 to second network transceiver 108 to begin the process of establishing a second communication session with second network transceiver 108 using a second protocol. In some embodiments, mobile station 102 may need to return to communicating with first network transceiver 104, as shown at data communication 508, wherein data 510 is received and responses are sent at 512. As part of data communication 508, mobile station 102 can schedule a third alternate network period.

During a third alternate network period, mobile station 102 can receive authorization/association response 312, which authorizes mobile station 102 to communicate in a second communication session with second network transceiver 108. At this point, mobile station 102 can schedule time to return to the first communication session with first network transceiver 104 by sending power save request 514 and receiving power save response 516. Power save request 514 is a request for mobile station 102 to enter a power saving mode wherein mobile station 102 is not expected to receive or respond to communications with second network transceiver 108 for a defined period of time.

During the power save period granted by power save response 516, mobile station 102 can return to communicating with first network transceiver 104 in order to maintain the first communication session, as shown at 518. Because mobile station 102 has now established a second communication session with second network transceiver 108, mobile station 102 can optionally break the first communication session by sending request to break 314 and receiving, in response, break grant 316. Thereafter, mobile station 102 can continue communicating with second network transceiver 108 in the second communication session as shown at 318.

Thus, FIG. 5 illustrates an embodiment wherein mobile station 102 may have to periodically return to communicating with first network transceiver 104 in order to maintain a first communication session while mobile station 102 is negotiating with second network transceiver 108 to establish a second communication session. Mobile station 102 can use various techniques, such as requesting scan intervals, to schedule alternate network periods to temporarily allow mobile station 102 to communicate with second network transceiver 108 in order to establish the second communication session before breaking the first communication session. Establishing the second session before breaking the first session can have advantages, such as the ability to transfer an ongoing data session (e.g., streaming data) from the first session to the second session.

Although the invention is described herein with reference to specific embodiments, various modifications and changes can be made without departing from the scope of the present invention as set forth in the claims below. For example, while the techniques and apparatus for switching a mobile station from a first network to a second network may vary widely, one or more embodiments can be used in wireless networks, Internet networks, and cellular networks. Accordingly, the specification and figures are to be regarded in an illustrative rather than in a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for switching communication networks comprising:
scheduling an alternate network period during a first communication session between a mobile station and a first network transceiver in a first network, wherein the first network uses a first protocol;
searching for a transmission from a second network transceiver in a second network during the alternate network period, wherein the mobile station operates during the alternate network period exclusively using a second protocol that is used by the second network;
requesting a second communication session between the mobile station and the second network transceiver; and
initiating a second communication session between the mobile station and the second network transceiver.

2. The method for switching communication networks according to claim 1 wherein the alternate network period is a period in which a transmission from the first network transceiver to the mobile station is not defined by the first protocol.

3. The method for switching communication networks according to claim 1 wherein the alternate network period is a period in which a transmission from the first network transceiver to the mobile station can be ignored by the mobile station without terminating the first communication session.

4. The method for switching communication networks according to claim 1 further comprising terminating the first communication session between the mobile station and the first network transceiver.

5. The method for switching communication networks according to claim 1 wherein the searching for the transmission from the second network transceiver comprises transmitting a probe request for the second network transceiver and searching for a probe response from the second network transceiver.

6. The method for switching communication networks according to claim 1 wherein the searching for the transmission from the second network transceiver comprises searching for a beacon from the second network transceiver.

7. The method for switching communication networks according to claim 1 wherein the first protocol comprises a protocol substantially in accordance with an IEEE 802.16 specification.

8. The method for switching communication networks according to claim 1 further comprising:
determining that the alternate network period has expired;
scheduling a second alternate network period during the first communication session; and
during the second alternate network period, requesting the second communication session between the mobile station and the second network transceiver.

9. The method for switching communication networks according to claim 1 wherein the initiating the second communication session comprises:
periodically scheduling additional alternate network periods; and
during each additional alternate network period, negotiating the second communication session between the mobile station and the second network transceiver.

10. The method for switching communication networks according to claim 1 wherein the requesting the second communication session comprises requesting a second communication session during the alternate network period.

11. The method for switching communication networks according to claim 1 further comprising:
disabling a first mobile transceiver that is configured to use the first protocol; and
enabling a second mobile transceiver that is configured to use the second protocol prior to the searching for a transmission from a second network transceiver in a second network.

12. A mobile station comprising:
a mobile transceiver for communicating with a first network transceiver in a first communication session using a first protocol, and for communicating with a second network transceiver using a second protocol, wherein communicating using the first protocol and using the second protocol are mutually exclusive;
a network controller coupled to the mobile transceiver for controlling the mobile transceiver; and
an alternate network scheduler coupled to the network controller for scheduling second network communications between the mobile transceiver and the second network transceiver before a termination of the first communication session, wherein the second network communications are for detecting the second network transceiver and initiating a second communication session between the mobile station and the second network transceiver.

13. The mobile station according to claim 12 wherein the mobile transceiver comprises a first mobile transceiver, a second mobile transceiver, a mobile transceiver switch, and a network controller, wherein the mobile transceiver switch is coupled to the first and second mobile transceivers, a mobile transceiver input-output, and the network controller, wherein the network controller controls the mobile transceiver switch to exclusively enable communication by the mobile transceiver in either a first mode using the first protocol or a second mode using the second protocol.

14. The mobile station according to claim 12 wherein the alternate network scheduler comprises an alternate network scheduler for transmitting a request to the first network transceiver for a scan interval.

15. The mobile station according to claim 12 wherein the network controller comprises a network controller for detecting a transmission from the second network transceiver during a second network communication.

16. The mobile station according to claim 12 wherein the network controller comprises a network controller for initiating transmission of an association request to the second network transceiver during a second network communication, prior to a termination of the first communication session.

17. The mobile station according to claim 12 wherein the first protocol comprises a first protocol substantially in accordance with an IEEE 802.16 specification.

18. A method for switching communication networks comprising:
scheduling an alternate network period during a first communication session by sending a search request from a mobile station to a first network transceiver, wherein the first communication session is between the mobile station and the first network transceiver, and the first network transceiver is in a first network that uses a first protocol;
searching for a transmission from a second network transceiver in a second network during the alternate network period, wherein the mobile station operates during the alternate network period exclusively using a second protocol that is used by the second network;
requesting a second communication session between the mobile station and the second network transceiver; and
initiating a second communication session between the mobile station and the second network transceiver.

19. The mobile station according to claim 18 wherein the searching for a transmission from a second network transceiver comprises searching for a beacon transmitted from the second network transceiver.

20. The mobile station according to claim 18 wherein the requesting a second communication session comprises sending an association request from the mobile station to the second network transceiver exclusively using the second protocol.
